(19) United States
(12) Patent Application Publication
(10) Pub. No.: US 2013/0151997 A1
(43) Pub. Date: Jun. 13, 2013

(54) METHOD AND SYSTEM FOR INTERACTING WITH A WEB SITE

(71) Applicant: GLOBANT, LLC, Buenos Aries (AR)

(72) Inventor: MARTIN MIGOYA, HUDSON (AR)

(73) Assignee: GLOBANT, LLC, BUENOS ARIES (AR)

(21) Appl. No.: 13/707,202

(22) Filed: Dec. 6, 2012

Related U.S. Application Data
(60) Provisional application No. 61/567,916, filed on Dec. 7, 2011.

(51) Int. Cl. G06F 3/0484

(52) U.S. Cl. CPC G06F 3/0484
USPC 715/760

(57) ABSTRACT

A method and system for a user to interact with a web site, comprising: accepting user input at a Web browser, wherein the user input is a string indicating what the user wishes to do on the web site; processing the user input, the processing comprising determining various matching patterns and assigning a weight to each potential matching pattern, the matching patterns relating user inputs to potential actions, and the weight indicating how likely the matching pattern is being used by the user to implement a certain action; and pre-populating a interface action screen using information from the processed user input.

### CROSS-REFERENCE TO RELATED APPLICATIONS

This application claims the benefit of U.S. Provisional Application No. 61/567,916, filed Dec. 7, 2011, which is incorporated by reference in its entirety.

### BRIEF DESCRIPTION OF THE FIGURES

FIG. 1 illustrates a system for interacting with a web site, according to an embodiment.

FIG. 2 sets forth details of an NPL application, according to an embodiment.

FIG. 3 illustrates a method of interacting with a web site, according to an embodiment.

FIG. 4 illustrates details related to whether a user wishes to utilize information from a social network site, according to an embodiment.

FIGS. 5-7 and 9-10 illustrate various user interfaces that may be used in a system for interacting with a web site, according to an embodiment.

FIG. 8 illustrates an example of utilizing a social network, according to an embodiment.

FIGS. 11-12 illustrates some example actions with their corresponding matching patterns and weights, according to an embodiment.

### DETAILED DESCRIPTION OF EMBODIMENTS OF THE INVENTION

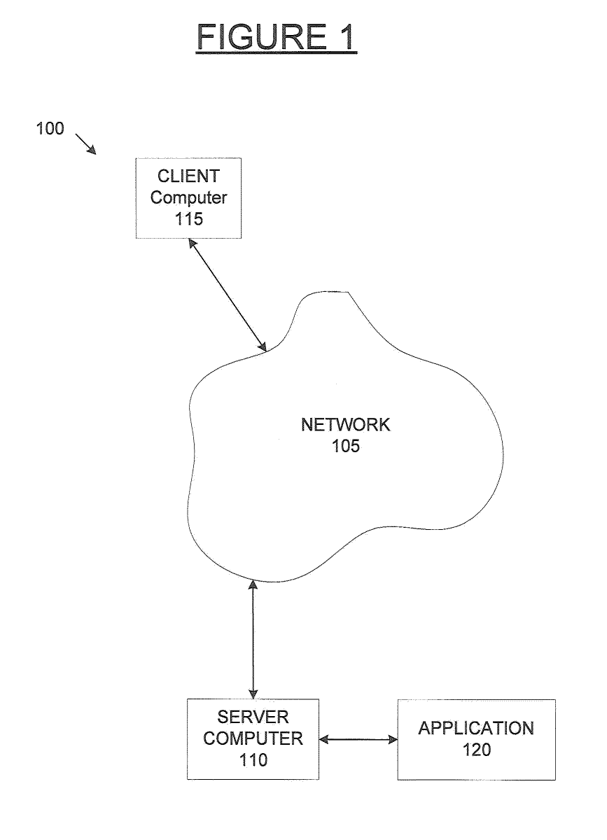

FIG. 1 illustrates a system for interacting with a web site, according to an embodiment. In one embodiment, user input, which may be a string indicating what the user wishes to do on the web site, may be input using a Web browser. The user input is processed, and a user interface action screen may be pre-populated using information from the processed user input. System 100 may include, but is not limited to: a client computer 115 communicating with a server computer 110 over a network 105 utilizing a natural language processing (NLP) application 120. The NLP application 120 may run utilizing server computer 110. The network 105 may comprise the Internet, or an intranet, or any other network, or any combination thereof. The client computer 115 and server computer 110 may comprise a computer. The computer may be any programmable machine capable of performing arithmetic and/or logical operations. In some embodiments, computers may comprise processors, memories, data storage devices, and/or other commonly known or novel components. These components may be connected physically or through network or wireless links. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers.

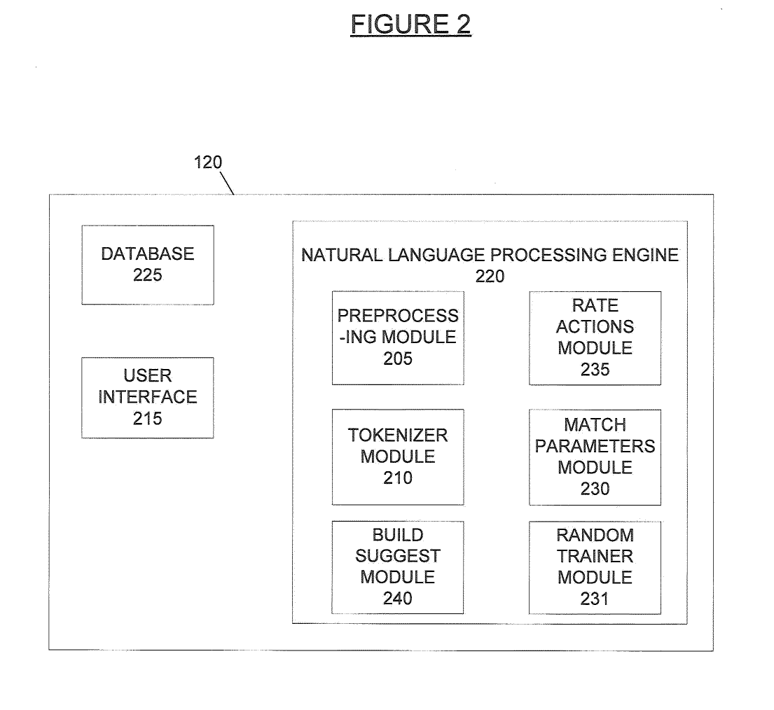

FIG. 2 sets forth details of the NPL application 120, according to an embodiment. The NPL application 120 may include a user interface 215, a database 225, and a NPL engine 220. The user interface 215 may be used to provide screens to the user with which the user may interact with the NPL engine 220. The database 225 may store information utilized by the NPL engine 220, such as an operation log, information from social network sites, etc.

The NPL engine 220 may be a flexible configuration, which may be modified in real time. The NPL engine 220 may be used on any standard Web browser, executed both on the browser (quick response) or server (large set of operations), and may employ JavaScript and/or a Google Web Toolkit (GWT) to run the code on the browser. The NPL engine 220 may be responsible for matching user input to predefined available actions. Each action may be defined as an action or operation a user may do in the Web site, and may contain a set of parameters. For example, an action of transferring money to a contact may be called “transfer money” and may require “amount to transfer” and “currency” parameters.

The NPL engine 220 may comprise: a preprocessing module 205, a tokenizer module 210, a rate actions module 235, a match parameters module 230, a random trainer module 231, or a build suggest module 240, or any combination thereof.

The preprocessing module 205 may perform simple operations on the user input string, such as, but not limited to: converting text to lower case, eliminating multiple and/or duplicative spaces, inserting a space (e.g., between a symbol and a number), performing a spell check, or replacing keywords entered by the user with replacement objects, or any combination thereof. Converting text to lower case, eliminating multiple and/or duplicative spaces, inserting a space, and performing a spell check may be done using techniques known by those experienced in the art.

With respect to replacing keywords entered by the user with replacement objects, if the replacement object is a number, the parameter may be replaced by this number. If the replacement object is a string, the parameter may be replaced by this string. If the replacement object is a function, the parameter value may be the result of calling this function using the value taken from the user input. A replacement object may also comprise any combination of a number, string, and function. Replacing keywords with replacement objects may be done by using previously defined sets of keywords with their replacement phrases. For an example of the replacement object being a string, note that date phrases may all be put in the same format (e.g., “yesterday”, “# days ago” can be changed to a “DD/MM/YY” format).

The tokenizer module 210 may split the user input string into tokens/words, and may consider language specific situations. For example, the tokenizer module 210 may move symbols of currency (e.g., $) to after a number for certain currencies, and to before a number for other currencies, in order to take language specific situations into account. The tokenizer module 210 may help normalize the user input string so that the rate action module 235 may more easily determine which weights should be assigned to which matching patterns (e.g. patterns of words, symbols, etc.). The tokenizer module 210 may convert an input string to a sequence of tokens. Each token may be, for example, one word and/or symbol, a combination of words and/or symbols, etc. The tokenizer module 210 may also: delete words that are present in almost all phrases (e.g., prepositions, articles, etc.); compare each word with a dictionary to fix common typing mistakes; replace some words with synonyms to simplify processing: replace common phrases with other words or phrases; or eliminate some prepositions which are not relevant; or any combination thereof. For example, the tokenizer module 210 may normalize the phrase “I need to transfer $100 to my Facebook friend @gpraino” by correcting “firend” to “friend” and also converting all the words in the phrase to lowercase words. The following common words and phrases may be removed: “I need to”, “to”, “my”. The word “transfer” may be changed to “send”. The phrase “$100” may be changed to “$100”. The following words may thus be used as tokens: “send”, “$100”, “Facebook”, “friend”, or “@gpraino”, or any combination thereof.

With respect to fixing typos, this may be done by comparing all words in the phrase with a word dictionary. Words that are not listed in the dictionary may be considered potential typing mistakes. When this happens, it may be determined whether there's a word in the dictionary that looks like the one the user typed, with one of the following differences:
The words have the same letters, but the order of 2 consecutive letters have been swapped (e.g., firend v. friend).
The words have just one letter different (a letter has been added, is missing or has been changed) (e.g., frifay v. friday, suday v. sunday, satturday v. saturday).

Words starting with capital letter may be ignored, as they are assumed to be a name. Note that this may be done before converting the phrase to lowercase. The proximity of the keys in the keyboard may also be considered when evaluating a potential fax for a typed word not in the dictionary.

The rate action module 235 may assign a weight to each matching pattern, the weight indicating how likely the matching pattern is being used by the user to implement a certain action. A “matching pattern” may comprise known variations of words, phrases, symbols, etc. (e.g., usd, us$, dollar, dollars, $, $us may all be defined as matches for ‘dollar’). The weights may be determined using a training algorithm, which is discussed in more detail below.

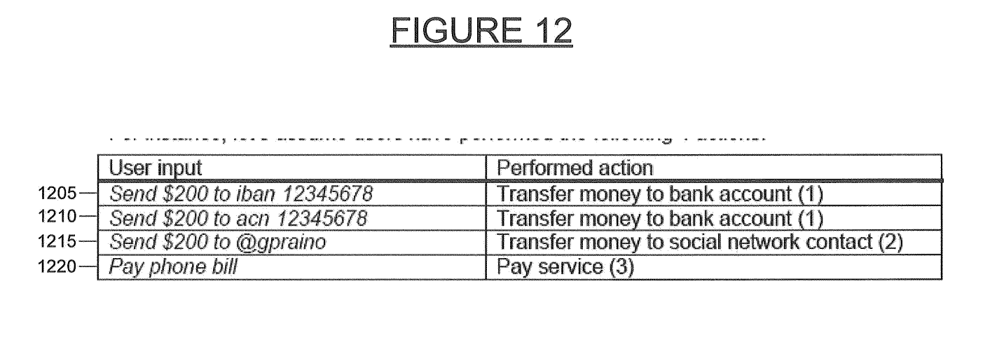

The training algorithm may use every stored user input and performed action. Thus, for example, the history of all inputs users have typed and what action the user eventually did may be stored. This information may be used by the training algorithm to automatically build or adjust matching rules. The matching rules may comprise the matching patterns and their corresponding weights. For example, users may enter user inputs and then perform actions, and the rate actions module 235 may store the information, such as the information shown in FIG. 12. The rate actions module 235 may then process the pairs shown in FIG. 12 to build or adjust the weights and matching patterns in the matching rules, as set forth in the training algorithm. For example, if the word “send” is frequently used when performing, action 1205, but also used when specifying action 1210, the matching word “send” may be assigned an average weight for action 1205 (e.g., 0.4). As “iban” is only used to perform action 1205, “iban” may be assigned a high weight for action 1205 (e.g., 0.9). If the matching pattern “pay” near “phone” is frequently used to specify action 1220, it may be assigned a high weight (e.g., 0.9).

Training may be performed both manually and automatically. The training algorithm may perform automatic training as described above. Training may also be done manually by having, for example, an administrator define a matching rule (e.g., a matching pattern and its corresponding weight, that is, how likely it is the matching pattern is being used by the user to perform a particular action).

The weight calculation in the training algorithm may consider how often each matching pattern is being used to specify each action. The weight calculation also may modify certain weights randomly to maximize matching scores for defined actions.

In one embodiment, the training algorithm may be a offline process which may be executed periodically to adjust pattern recognition. The training algorithm may analyze the log history of pairs of user inputs and executed actions to identify patterns and adjust engine recognition.

The training algorithm may identify representative tokens that have been used as user inputs for each executed action and may assign each token a rate from 0 to 1. This number from 0 to 1 may represent the probability that a certain token identifies a given action. To do this, the training algorithm may analyze how many times each token has been used to describe each action. If a given token is frequently used to describe a certain action, but not other actions, then it's assigned a higher probability for the certain action. In one embodiment, this probability may be found by using the following formula:

% of time token used for particular action/% of time token used for all actions

For example, assume the training algorithm has only the following two actions: PAY SERVICE and TRANSFER MONEY TO CONTACT. Lets also assume that the training algorithm has a record of only the following seven phases being used by users to describe the two actions:

### PAY SERVICE:

pay phone bill
pay insurance
pay credit card
phone bill

### TRANSFER MONEY TO CONTACT:

### pay $100 to Jim

send $100 to John
send $100 to Smith

Because the token “pay” is used in 75% of the user inputs that result in the first action (i.e., PAY SERVICE) and only in 33% of the user inputs for the second action (i.e., TRANSFER MONEY TO CONTACT), the token “pay” may be assigned a weight of 75/(75+33)=0.69 for the first action and a weight of 33/(75+33)=0.30 for the second action. Similarly, because the token “send” is used in 0% of the user inputs for the first action and in 66% of the user inputs for the second actions, the token “send” may be assigned a weight of 0/(0+66)=0 for the first action, and a weight of 66/(0+66)=1 for the second action. This illustrates that when a token is only present in a single action, it may be given a weight of 1.

Finally, the random trainer module 231 may randomly modify the weight of certain keywords and determine whether this improves the matching probability for all stored actions. This may be used to fix some overlapping when two or more actions may be described by very similar combinations of keywords This may be done by reviewing a historical log of records relating to user input and the resulting performed action. The random trainer module 231 may compare the predicted action with the performed action. For example, a current error field could be set equal to the number of predicted actions that were mistakes. The random trainer module 231 may then adjust the weights of the predicted actions that were mistakes. This may decrease the rating of the predicted actions that had mistakes and increase the rating of the actions that should have been predicted. This process may be repeated several times to increase the matching rate.

For example, the following may be utilized:

CurrentErrors = number of mistakes
For each record in historic log:

| | |
|---|---|
| inputPhrase | contains the user input |
| performedAction | contains the action performed by the user |

predictedAction = parseAction(record.inputPhrase)
if (predictedAction <> performedAction)
Multiply each weight in predictedAction rating by a random

number between 1 and 0.8

Multiply each weight in performedAction rating by a random

number between 1 and 1.2

FixedErrors = Count the number of mistakes done by the solution.
if (FixedErrors < CurrentErrors)

AcceptChange

else

DiscardChange

The location(s) of keywords entered by the user may be taken into account by the training algorithm. For example, when using the NPL application 120 on an airline service, a user may specify “I've lost a connection” or “I've lost my luggage on a connection.” Both phrases have “lost” and “connection” keywords, but the phrases obviously have very different meanings. Thus, in one embodiment, the following matching patterns may be utilized. If “lost” is near (e.g., within X number of words) to “connection”, this may be defined to be “request new flight”. If “lost” is near (e.g., within X number of words) to “luggage”, this may be defined to be “report lost luggage. In addition, keyword location may be useful when identifying parameters. For example, the following phrases have the same words, but in a different order: “convert 200 euros to dollars”; “convert 200 dollars to euros”. The “sourceCurrency” and “targetCurrency” parameters are identified by using combination of keyword patterns. Thus, for example, if “euros” is before the word “to”, this may be defined to mean “sourceCurrency”. If “euros” is after the word “to”, this may be defined to mean “targetCurrency”.

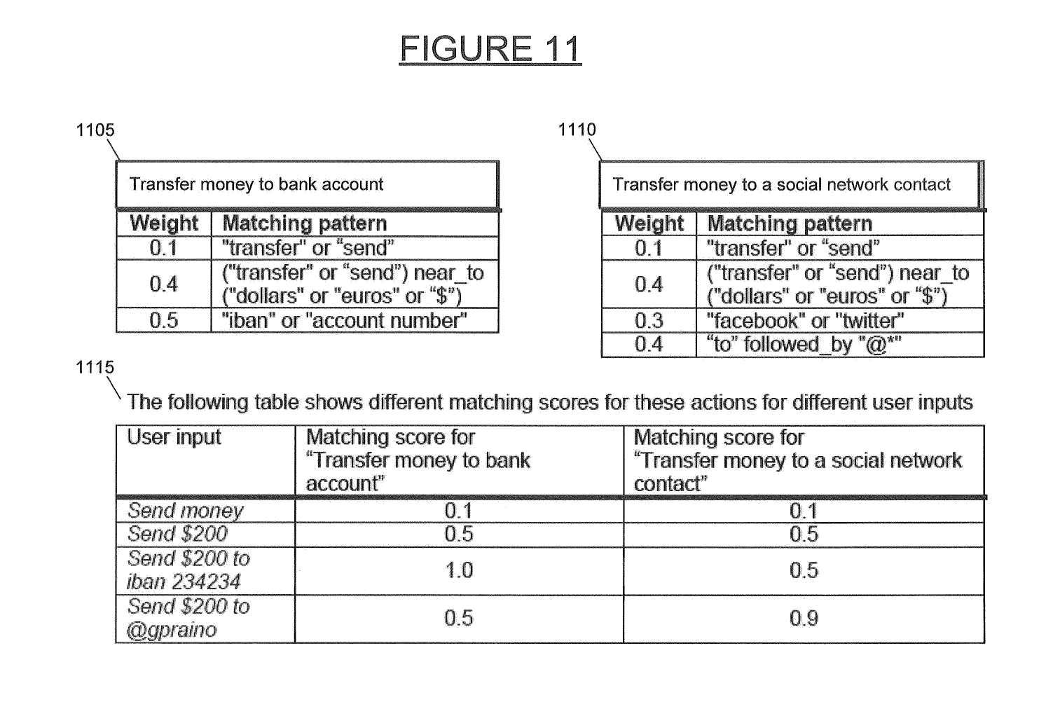

The match parameters module 230 may determine the top matching actions by using the matching rules from the rate actions module 235. FIG. 11 illustrates some actions with their corresponding matching patterns and weights, according to an embodiment. In 1105, the action entitled “transfer money to bank account” may have the following matching patterns and corresponding weights: matching pattern “transfer” or “send” is determined to have a weight of 0.1; matching pattern (“transfer” or “send”) near_to (“dollars” or “euros” or “$”) is defined to have a weight of 0.4; “iban” or “account number” is defined to have a weight of 0.5. In 1110, the action entitled “transfer money to a social network contact” may have the following matching patterns and corresponding weights: matching pattern “transfer” or “send” is defined to have a weight of 0.1; matching pattern (“transfer” or “send”) near_to (“dollars” or “euros” or “$”) is defined to have a weight of 0.4; matching pattern “facebook” or “twitter” is defined to have a weight of 0.4; matching pattern “to” following by “@” is defined to have a weight of 0.4. In 1115, different matching scores for different user inputs are shown: user input “send money” has a matching score of 0.1 for the action “transfer money to bank account”, and a matching score of 0.1 for the action “transfer money to a social network contact”: user input “send $200” has a matching score of 0.5 for the action “transfer money to bank account”; and a matching score of 0.5 for the action “transfer money to a social network contact”; user input “send $200 to iban 234234” has a matching score of 1.0 for the action “transfer money to bank account”, and a matching score of 0.5 for the action “transfer money to a social network contact”; and user input “send $200 to @gpraino” has a matching score of 0.5 for the action “transfer money to bank account”, and a matching score of 0.9 for the action “transfer money to a social network contact”. Note that when the user input has more than one matching pattern with a defined weight, the weights may be added together to get a new weight for the combined matching patterns. Although only positive weights have been shown in the examples in FIG. 11, negative weights may also be used.

The build suggest module 240 may generate a suggest string based on the top matching actions found by the match parameters module 230. The suggest string is the action name, for example “transfer money to bank account” or “transfer money to a social network contact” in 1205 and 1215 of FIG. 12. Every time the user types something in the input box, the NPL application 120 may check what the user has typed so far, and determines any matching patterns and associated weights. Actions corresponding to the matching patterns with the highest weights may be displayed to the user so that the user may choose an action. For example, the top three actions, or any actions that have a weight of greater than 0.9, may be displayed. Which options to show may be set by an administrator.

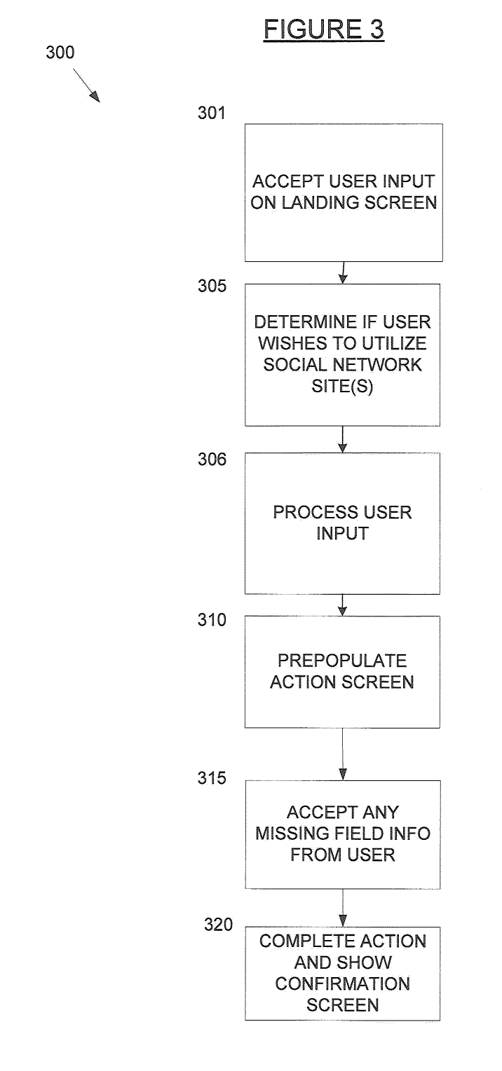

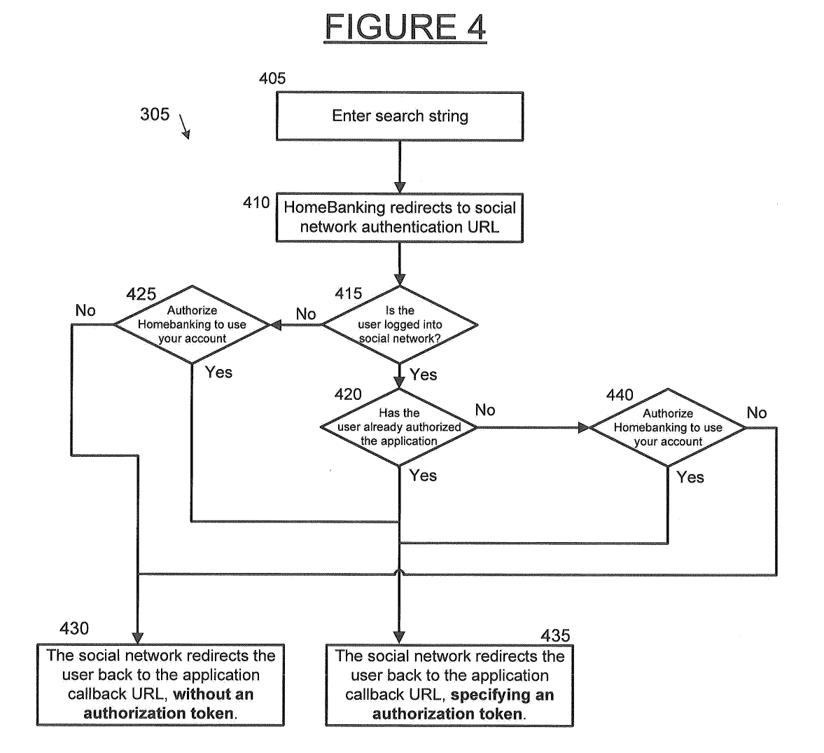

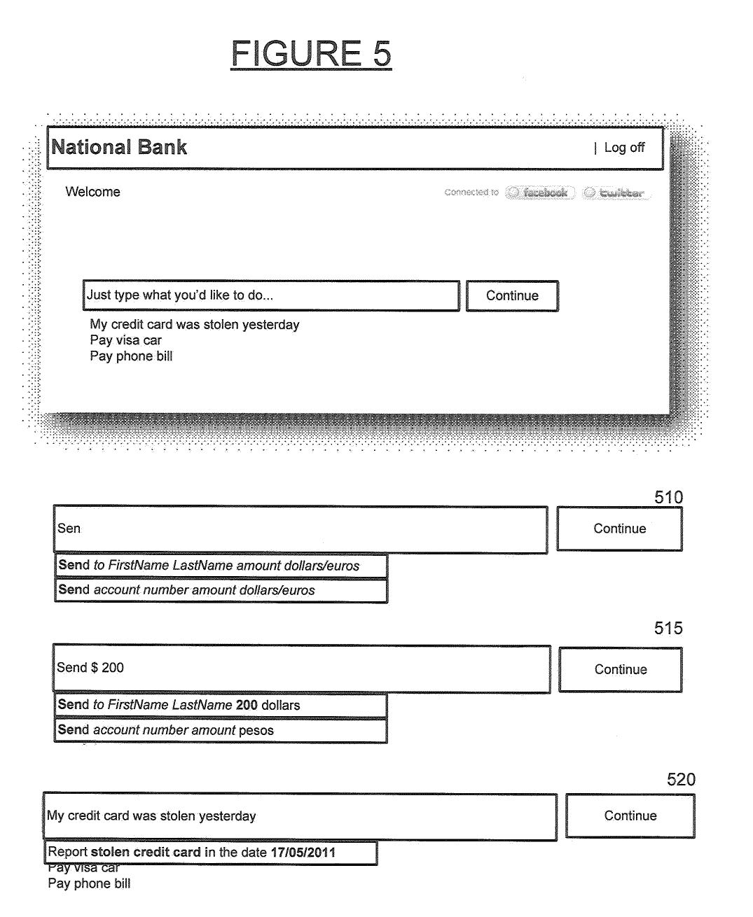

FIG. 3 illustrates a method 300 of interacting with a web site, according to an embodiment. In 301, user input may be accepted on a landing screen, which may be a user interface screen. The user input may comprise a string. In this manner, the user may indicate what the user wishes to do rather than, or in addition to, the option of using hyperlinks or menus. Thus, for example, in FIG. 5, when a user logs into a web site, the user may see a space where a string may be entered. In 510, 515, and 520, examples of strings that may be entered are shown. In 305, it may be determined whether a user wishes to utilize information from a social network site (e.g., Facebook, Twitter). (This is explained in more detail in the explanation of FIG. 4 below.)

In 306, the user input may be processed, as described above with respect to modules 205, 210, 235, 230 and 240. For example, referring to FIG. 5, 510, 515, and 520 show examples of how the string the user is entering may be guessed by the NPL application 120, where any guessed actions are shown under the box.

Once the user chooses an option guessed by the NPL application 120, or otherwise finishes entering a string, in 310, an action screen, which may be a user interface screen, may be pre-populated with one or more menus. Each action screen, including its menus, may be preset by, for example, an administrator, for each action name. Any parameters that are associated with the action name or set of action names may also be returned as data in the menus. The menus may be presented in an easy-to-use format on the action screen.

In 315, any missing information may be accepted from the user and the action may be completed. In 320, a confirmation screen, which may be a user interface screen, may be shown.

if a problem is detected when an action screen is attempting to pre-populate, the problem may be directed for further analysis. For example, the problem may be directed to a person (e.g., administrator) who may manually adjust engine rules to match the intended operation. Example problems comprise: no action matches the input user string; the user indicates the operation did not succeed by clicking a button on the landing page; the user cancels the operation after it is completed; or the user entered parameters different from the suggested parameters; or any combination thereof. Many other problems may be included.

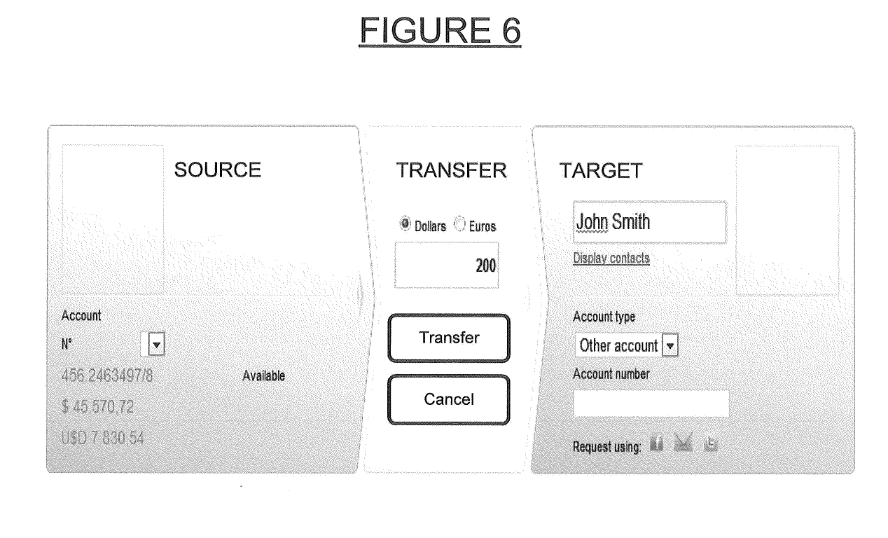

FIGS. 6-7 and 9-10 illustrate examples of pre-populated action screens. FIG. 6 illustrates an example money transfer operation action screen, where the account number and account information, transfer amount, and transferee information are pre-populated and shown to the user in an easy to use format.

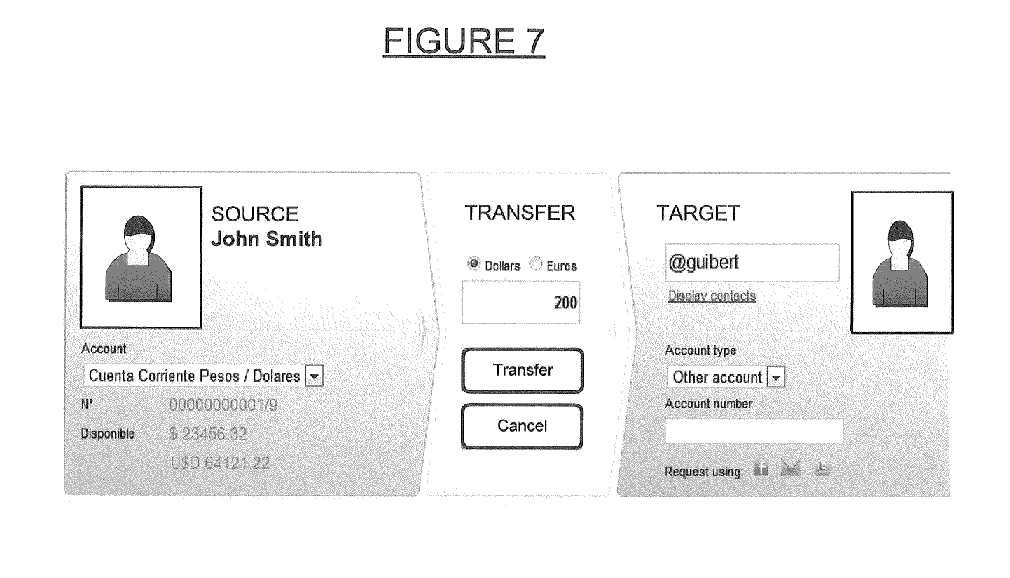

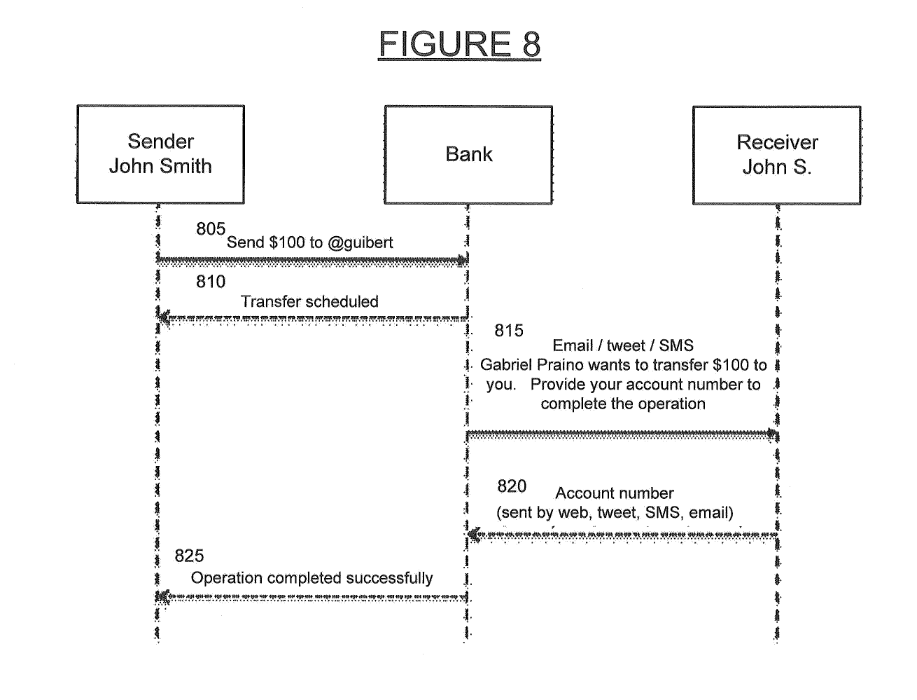

FIG. 7 illustrates an example of another money transfer operation action screen, where an email address, user name, etc. is entered for a contact in a social network account (e.g., Twitter). In this example, the NPL application 120 can pull the information (e.g., account number, legal name) it needs from Twitter (e.g., stored in database 225 or obtained from Twitter in real-time) in order to complete the money transfer. The social networking site may also be used to allow the user to request information from the contact. For example, if the user wishes to transfer money to a Twitter contact, but does not know the contact's bank account number, the user may click a social network link on the action screen, and let the NPL application 120 retrieve this information from the corresponding social network. (This is explained in more detail in the explanation of FIG. 8 below.)

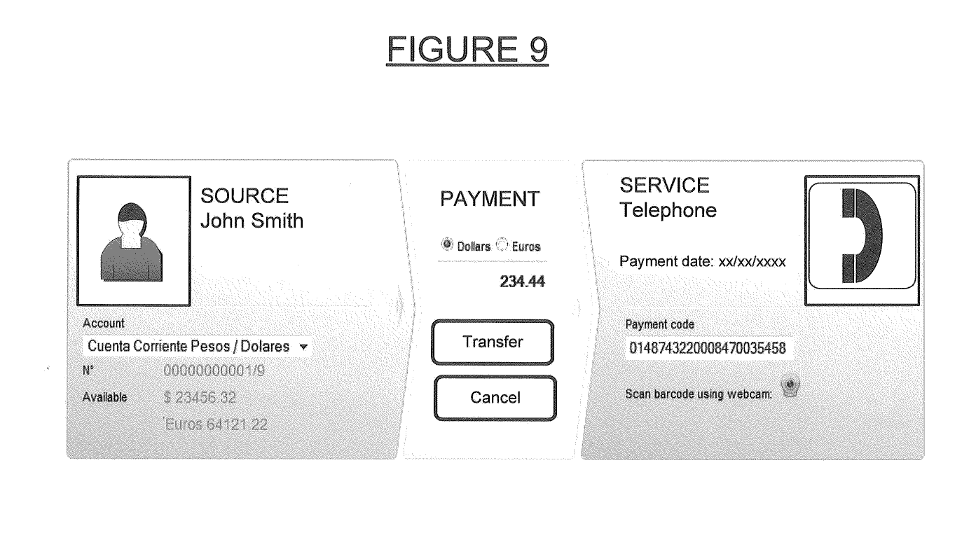

FIG. 9 illustrates an example of a service payment action screen. In this example, the user may pay a phone bill by typing “pay phone”, etc. The NLP application 120 may pre-populate the action screen, select the next bill due to pay, and allow a user to confirm that choice, or choose a different bill to pay. In an embodiment, a user can scan a barcode of a paper or electronic bill, and that information may be added to the pre-populated action screen.

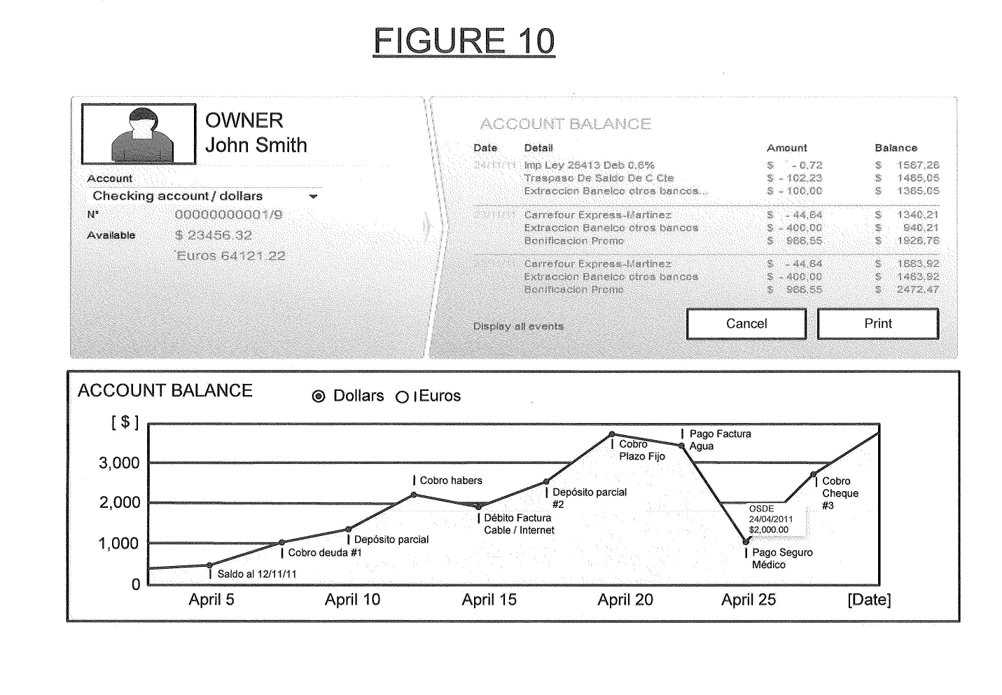

FIG. 10 illustrates an example of a check balance action screen. In this example, the action screen may show the account information, recent past activity and near future expected activity (based on past activity). The account balance information may also be presented to the user in graph form.

FIG. 4 illustrates details related to whether a user wishes to utilize information from a social network site (e.g., Facebook, Twitter) 305, according to an embodiment. In 405, the user enters a string, and checks an option for being connected to a social network (e.g., Facebook, Twitter). In 410, the NLP application 120 redirects the user to a social network authorization URL. In 415, it is determined whether the user is logged into the social network. If no, the user is not logged in, in 425 the user logs in, and authorizes the account, and the process moves to 435. If yes, the user is logged in, in 420, it is determined whether the user has already authorized the application. If no the user has not already authorized the application, in 440, the user authorizes the application. If yes the user has already authorized the application, in 435, the social network redirects the user back to the application callback URL, specifying an authorization token. In 425, if the user is not able to log in, or if the user does not authorize the application in 440, the social network may redirect the user back to the application callback URL without an authorization token in 430.

The authorization token may be used because at least three parties may be involved: the user, a social network, and the party operating the application 120. The user may have stored personal information (e.g., contacts) in a social network. The application 120 may request these contacts from the social network in order to suggest these contacts to the user. Because the social network has no way of knowing who is running application 120 and whether the user accepts the sharing of information, a shared secret process may be used for authentication purposes. The shared secret may allow the social network to authenticate the user and validate that the user accepts providing the specified information to the application 120.

FIG. 8 illustrates an example of utilizing a social network, according to an embodiment. In 805, the user (e.g., sender) may type in “send $100 to @guibert”. In 810, the bank may schedule the transfer. In 815, the bank may contact (e.g. using email, tweet, SMS, Internet, etc.) @guibert, and indicate that Gabriel Praino wants to transfer $100 to him/her/it. The bank may ask guibert to provide his/her/its account number. In 820, @guibert may provide his/her/its account number. In 825, the bank may finalize the transfer and notify the user.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than those shown. For example, the elements in the flowcharts may be performed in parallel or in a different order.

Further, the purpose of any Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. An Abstract of the Disclosure is not intended to be limiting as to the scope of the present invention in any way.

It should also be noted that the terms “a”, “an”, “the”, “said”, etc. signify “at least one” or “the at least one” in the application (e.g., specification, claims and drawings).

It should also be noted that “comprising” should be interpreted as meaning “including, but not limited to”.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for a user to interact with a web site, comprising:
accepting user input at a Web browser, wherein the user input is a string indicating what the user wishes to do on the web site;
processing the user input, the processing comprising determining various matching patterns and assigning a weight to each potential matching pattern, the matching patterns relating user inputs to potential actions, and the weight indicating how likely the matching pattern is being used by the user to implement a certain action; and
pre-populating a user interface action screen using information from the processed user input.

2. The method of claim 1, further comprising:
processing information related to: banking information; a most likely option; or information retrieved from a social network the user is connected to; or any combination thereof.

3. The method of claim 2, wherein the social network comprises: Facebook; Linked In; or Twitter; or any combination thereof.

4. The method of claim 1, wherein the string box provides a suggest box to guide the user to defined actions.

5. The method of claim 1, wherein the string is processed on the fly using a natural language processing engine which returns a probable matching action.

6. The method of claim 1, wherein the natural language processing engine also returns a probable matching action parameter.

7. The method of claim 1, wherein the information from the processed user input comprises determining the most likely option for what the user would like to do based on the string.

8. The method of claim 1, wherein the website is a home banking website and/or a travel industry website.

9. The method of claim 8, wherein the travel industry website is an airline website, a bus website, a train website, or a hotel website, or any combination thereof.

10. The method of claim 1, wherein processing the user input comprises preprocessing the user input, the preprocessing comprising: converting text to lower case; eliminating multiple and/or duplicative spaces; inserting a space; performing a spell check; or replacing keywords entered by the user with replacement objects, or any combination thereof.

11. The method of claim 10, wherein the replacement objects comprise: a number, a string, a function, or any combination thereof.

12. The method of claim 1, wherein the processing comprises splitting the user input into tokens.

13. The method of claim 12, wherein the tokens comprise: a word and/or a symbol.

14. The method of claim 12, wherein the processing comprises: deleting words that are present in almost all phrases; comparing each word with a dictionary to fix common typing mistakes; replacing some words with synonyms to simplify processing; replacing common phrases with other words or phrases; eliminating some prepositions which are not relevant; or any combination thereof.

15. The method of claim 14, wherein the comparing each word with a dictionary to fix common typing mistakes comprises determining whether there's a word in the dictionary that looks like the word the user typed, with at least on one of the following differences: the words have the same letters but the order of two consecutive letters have been swapped; and/or the words have one letter that is different.

16. The method of claim 14, wherein when comparing each word with a dictionary to fix common typing mistakes, considering the proximity of the keys in the keyboard when evaluating a potential fix.

17. The method of claim 1, wherein assigning the weight to each potential matching pattern further comprises: assigning a higher probability for a certain action if a token is frequently used to describe the certain action, but not other actions.

18. The method of claim 17, further comprising: modifying the weight of each potential matching pattern based on a historical log of records relating to user input and the resulting performed action.

19. A system for a user to interact with a web site, comprising:
a processor configured for:
accepting user input at a Web browser, wherein the user input is a string indicating what the user wishes to do on the web site;
processing the user input, the processing comprising determining various matching patterns and assigning a weight to each potential matching pattern, the matching patterns relating user inputs to potential actions, and the weight indicating how likely the matching pattern is being used by the user to implement a certain action; and
pre-populating a user interface action screen using information from the processed user input.

20. The system of claim 19, wherein the processor is further configured for:
processing information related to: banking information; a most likely option; or information retrieved from a social network the user is connected to; or any combination thereof.

21. The system of claim 20, wherein the social network comprises: Facebook; Linked In; or Twitter; or any combination thereof.

22. The system of claim 19, wherein the string box provides a suggest box to guide the user to defined actions.

23. The system of claim 19, wherein the string is processed on the fly using a natural language processing engine which returns a probable matching action.

24. The system of claim 19, wherein the natural language processing engine also returns a probable matching action parameter.

25. The system of claim 19, wherein the information from the processed user input comprises determining the most likely option for what the user would like to do based on the string.

26. The system of claim 19, wherein the website is a home banking website and/or a travel industry website.

27. The system of claim 26, wherein the travel industry website is an airline website, a bus website, a train website, or a hotel website, or any combination thereof.

28. The system of claim 19, wherein processing the user input comprises preprocessing the user input, the preprocessing comprising: converting text to lower case; eliminating multiple and/or duplicative spaces: inserting a space; performing a spell check; or replacing keywords entered by the user with replacement objects, or any combination thereof.

29. The system of claim 28, wherein the replacement objects comprise: a number, a string, a function, or any combination thereof.

30. The system of claim 19, wherein the processing comprises splitting the user input into tokens.

31. The system of claim 30, wherein the tokens comprise: a word and/or a symbol.

32. The system of claim 30, wherein the processing comprises: deleting words that are present in almost all phrases; comparing each word with a dictionary to fix common typing mistakes; replacing some words with synonyms to simplify processing; replacing common phrases with other words or phrases; eliminating some prepositions which are not relevant; or any combination thereof.

33. The system of claim 32, wherein the comparing each word with a dictionary to fix common typing mistakes comprises determining whether there's a word in the dictionary that looks like the word the user typed, with at least on one of the following differences: the words have the same letters but the order of two consecutive letters have been swapped; and/or the words have one letter that is different.

34. The system of claim 32, wherein when comparing each word with a dictionary to fix common typing mistakes, considering the proximity of the keys in the keyboard when evaluating a potential fix.

35. The system of claim 19, wherein assigning the weight to each potential matching pattern further comprises: assigning a higher probability for a certain action if a token is frequently used to describe the certain action, but not other actions.

36. The system of claim 35, further comprising: modifying the weight of each potential matching pattern based on a historical log of records relating to user input and the resulting performed action.
